(19) United States
(12) Patent Application Publication
(10) Pub. No.: US 2015/0076115 A1
(43) Pub. Date: Mar. 19, 2015

(54) ISOLATING/GROUNDING SWITCH WITH THREE PHASES IN ONE ENCLOSURE

(71) Applicant: SIEMENS AKTIENGESELLSCHAFT, MUENCHEN (DE)

(72) Inventor: Yan Ping Chen, Shanghai (CN)

(73) Assignee: SIEMENS AKTIENGESELLSCHAFT, MUENCHEN (DE)

(21) Appl. No.: 14/397,300

(22) PCT Filed: Apr. 11, 2013
(86) PCT No.: PCT/EP2013/057553

§ 371 Date: Oct. 27, 2014

(30) Foreign Application Priority Data
Apr. 28, 2012 (CN) 201210135013.0

(51) Int. Cl. H01H 33/02; H01H 33/42

(52) U.S. Cl. CPC H01H 33/022; H01H 33/42; H01H 2033/024
USPC 218/44

(57) ABSTRACT

An isolating/grounding switch with three phases in one enclosure has a simple conductor shape and a higher space utilization rate. The switch includes a housing, three first conductors and three second conductors, three first static contacts each connected to one of the first conductors, three second static contacts each connected to one of the second conductors, three moving contacts connected by an insulator, and three grounding contacts electrically connected to the housing. Each first static contact and a corresponding first conductor have the same axis as a corresponding second static contact and a corresponding second conductor. Each moving contact can slide on a corresponding first conductor and is electrically connected thereto. Each moving contact is electrically connected to a corresponding second static contact when at one end of a corresponding first conductor, and electrically connected to a corresponding grounding contact when at the other end of this first conductor.

### TECHNICAL FIELD

The present invention relates to an isolating/grounding switch with three phases in one enclosure, in particular to an isolating/grounding switch with three phases in one enclosure for a metal-enclosed gas-insulated switch device.

### BACKGROUND ART

In a metal-enclosed gas-insulated switch device, an isolation function and a grounding function, and three operational positions, namely a connected position, an isolated position and a grounded position, are generally realized by opening and closing an isolating/grounding switch. These isolating/grounding switches can be broadly divided into two types, rotational and straight-moving. Of these, the rotational type is restricted by the manner of contact, and so the nominal current that it is capable of carrying is lower, while the electrical performance thereof is poorer. As a result, most high-load metal-enclosed gas-insulated switch devices employ straight-moving isolating/grounding switches. Chinese utility model 200820032556 has disclosed a straight-moving isolating/grounding switch of this type. Compared to the rotational type, the straight-moving type occupies more space. In addition, the three phase conductors must be joined as one in the isolating/grounding switch to achieve coordination with the drive mechanism, while it is also necessary to subject the housing to deformation processing in order that the various contacts are arranged in a straight line to accomplish switching.

### Content of the Invention

The object of the present invention is to provide an isolating/grounding switch with three phases in one enclosure, which has a simple conductor shape and a higher space utilization rate. Such an isolating/grounding switch with three phases in one enclosure comprises a housing, three first conductors and three second conductors. The switch also comprises three first static contacts each connected to one of the first conductors, three second static contacts each connected to one of the second conductors, three moving contacts connected by an insulator, and three grounding contacts electrically connected to the housing. Each of the first static contacts and a corresponding one of the first conductors have the same axis as a corresponding one of the second static contacts and a corresponding one of the second conductors. Each of the moving contacts can slide on a corresponding one of the first conductors and is electrically connected to this first conductor. Each of the moving contacts is electrically connected to a corresponding one of the second static contacts when at one end of a corresponding one of the first conductors, and electrically connected to a corresponding one of the grounding contacts when at the other end of this first conductor. By establishing a direct electrical connection between each first static contact and a corresponding second static contact, there is no longer a need to join three conductors as one, and so a simple conductor shape and a higher space utilization rate are achieved. As a result of each of the first static contacts and a corresponding one of the first conductors having the same axis as a corresponding one of the second static contacts and a corresponding one of the second conductors, an electrical connection between the grounding contacts and the housing can be established simply, so that there is no need for the housing to undergo deformation processing. The above solution also allows a driving mechanism to have fewer components, so that the production costs of the switch are reduced while further improving the reliability thereof.

According to one embodiment of the present invention, the first conductors are arranged in a triangle on an insulating disk of the housing. The triangular arrangement helps to increase the space utilization rate and improve the insulating properties of the switch.

According to another embodiment of the present invention, the first conductors are arranged in a regular triangle on an insulating disk of the housing. The regular triangular arrangement can utilize space to the greatest extent possible, in order to achieve better insulating properties.

According to another embodiment of the present invention, the grounding contacts are three annular grounding contacts, each of the first conductors passing through a corresponding one of the grounding contacts, and the grounding contacts being electrically connected to the housing separately. By providing each of the first conductors with an independent grounding contact and connecting this to the housing, the connection between the grounding contacts and the housing, and the contact between the grounding contacts and the moving contacts, are made more reliable.

According to another embodiment of the present invention, the switch also comprises a crank arm, the crank arm being connected to the insulator and able to drive the moving contacts to slide on the first conductors. The provision of the crank arm helps to achieve the conversion of rotational movement of the driving mechanism to sliding movement of the moving contact in a simple manner.

According to another embodiment of the present invention, the second conductors are arranged in a regular triangle on the insulating disk of the housing, and at least one of the second conductors is bent. The bending of the second conductor helps to guarantee an insulating distance between the first static contacts and the second conductors in a limited space.

According to another embodiment of the present invention, only one of the second conductors is bent. When both the first conductors and the second conductors are arranged in a regular triangle on the insulating disk of the housing, disposing one of the second conductors close to the first conductor and bending the same helps to reduce the number of conductor processing steps and achieve a simpler structure.

According to another embodiment of the present invention, the housing is T-shaped and comprises a horizontal portion and a vertical portion, the first conductors being located in the horizontal portion, and the second conductors being located in the vertical portion.

According to another embodiment of the present invention, the housing is cross-shaped and comprises a horizontal portion and a vertical portion, the first conductors being located in the horizontal portion, and the second conductors being located in the vertical portion.

According to another embodiment of the present invention, the switch also comprises a driving mechanism connected to the crank arm, the driving mechanism being able to drive the crank arm and thereby drive the sliding movement of the moving contacts.

Preferred embodiments will be described below in a clear and easily understandable way with reference to the accompanying drawings, in order to further illustrate the above characteristics, technical features and advantages of the method used in the present invention, and embodiments thereof.

### DESCRIPTION OF THE ACCOMPANYING DRAWINGS

FIG. 1 shows schematically a partial sectional drawing of the isolating/grounding switch with three phases in one enclosure of the present invention;

FIG. 2 shows schematically the three first conductors mounted on the insulating disk and corresponding first static contacts in FIG. 1;

FIG. 3 shows schematically the coordination of the grounding contacts with corresponding first conductors and the housing in FIG. 1;

FIG. 4 shows schematically the three moving contacts connected by the insulator in FIG. 1;

FIG. 5 shows schematically the three second conductors mounted on the insulating disk and corresponding second static contacts in FIG. 1;

FIG. 6 shows schematically the insulator in FIG. 4;

FIG. 7 shows schematically the crank arm in FIG. 1.

### EXPLANATION OF LABELS

1 first conductor
11 first static contact
2 moving contact
3 crank arm
4 grounding contact
5 second conductor
51 second static contact
6 insulator
7 insulating disk
8 housing

### PARTICULAR EMBODIMENTS

In order that the technical features, object and effects of the present invention may be more clearly understood, particular embodiments of the present invention will now be described with reference to the accompanying drawings, in which identical labels indicate identical components or components which are similar in structure but identical in function.

In order that the drawings may appear concise, only those parts which are relevant to the present invention are represented schematically in the drawings; they do not represent the actual structure thereof as a product. In addition, in order to make the drawings appear concise for ease of understanding, in the case of components with the same structure or function, in some drawings only one of these is drawn schematically, or only one is labeled.

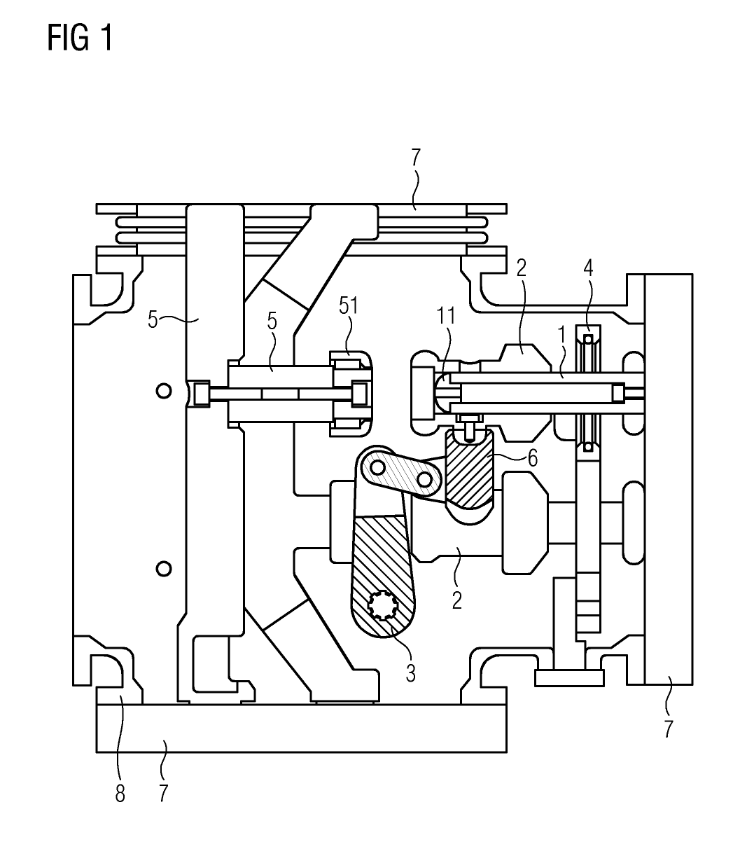

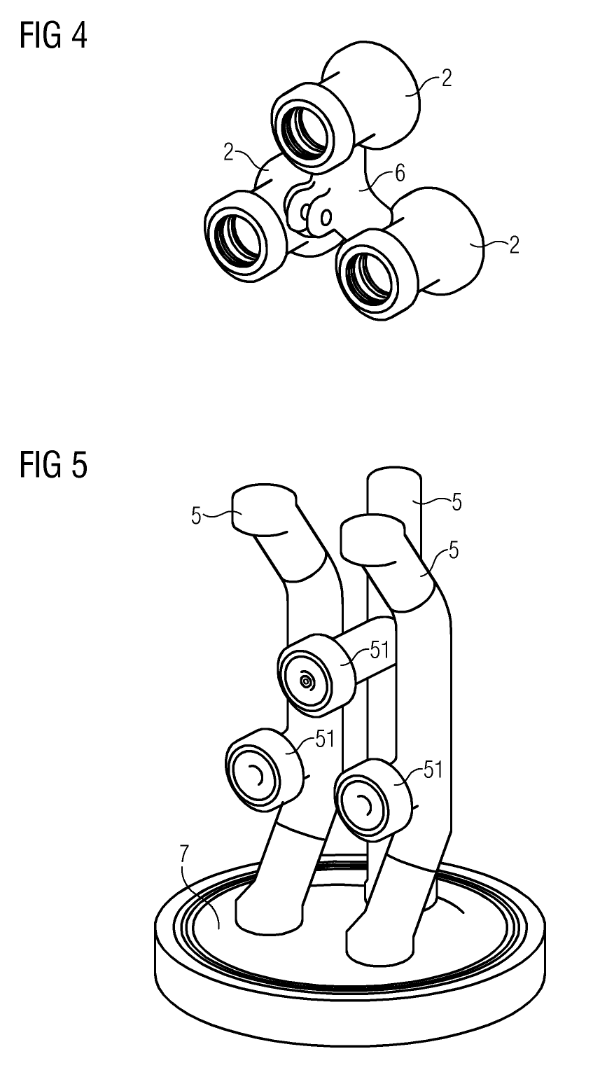

The isolating/grounding switch with three phases in one enclosure of the present invention that is shown schematically in FIG. 1 comprises a housing 8, three first conductors 1 and three second conductors 5. The switch also comprises three first static contacts 11 each connected to one of the first conductors 1, three second static contacts 51 each connected to one of the second conductors 5, three moving contacts 2 connected by an insulator 6 (see FIG. 4), and three grounding contacts 4 electrically connected to the housing 8. As FIG. 1 shows, each first static contact 11 (and corresponding first conductor 1) has the same axis as a corresponding second static contact 51 (and corresponding second conductor 5). Each moving contact 2 can slide on a corresponding first conductor 1 and is electrically connected to this first conductor 1. Each moving contact 2 is electrically connected to a corresponding second static contact 51 when at one end of the corresponding first conductor 1, and electrically connected to a corresponding grounding contact 4 when at the other end of this first conductor 1. The first static contact 11 and first conductor 1 are both made of conductive material, and may be produced separately and subsequently assembled. The electrical connection between the moving contact 2 and the corresponding first conductor 1 is mainly accomplished by direct contact with the first conductor 1.

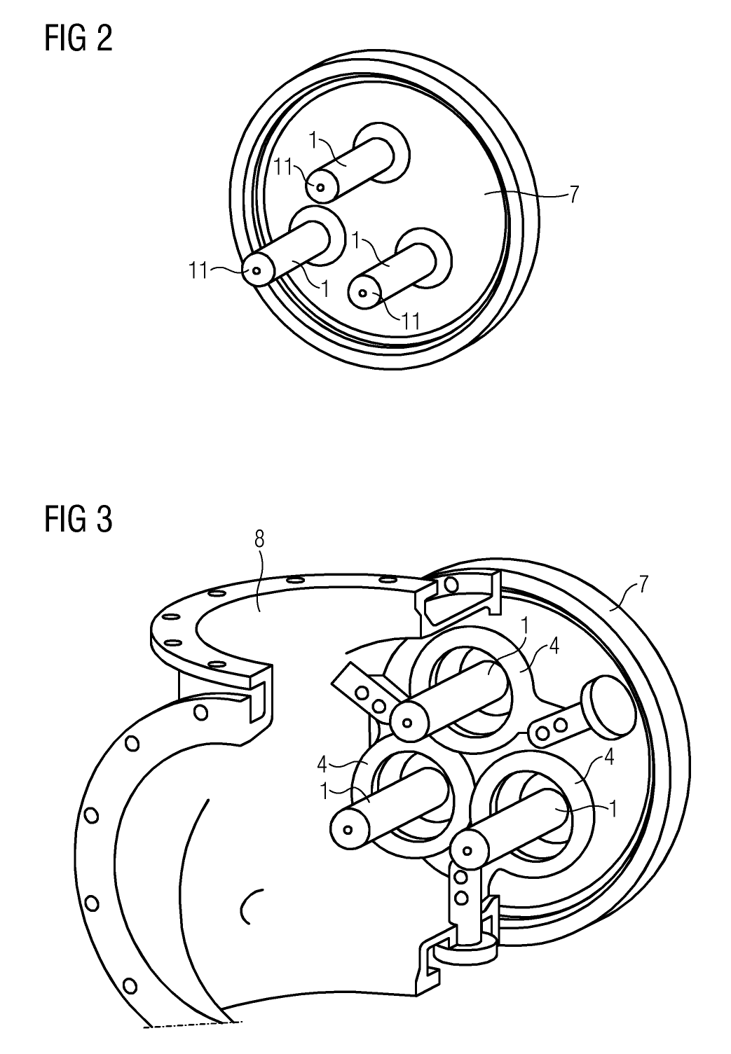

FIG. 2 shows schematically the three first conductors 1 mounted on an insulating disk 7 and corresponding first static contacts 11 in FIG. 1. The three first conductors 1 are preferably arranged in a regular triangle on the insulating disk 7 of the housing 8, as shown in FIG. 2, but may also be arranged in another triangular shape or in a straight line.

FIG. 3 shows schematically the coordination of the grounding contacts 4 with corresponding first conductors 1 and the housing 8 in FIG. 1, wherein the grounding contacts are three annular grounding contacts 4, each first conductor 1 passes through a corresponding grounding contact 4, and the grounding contacts 4 are electrically connected to the housing 8 separately.

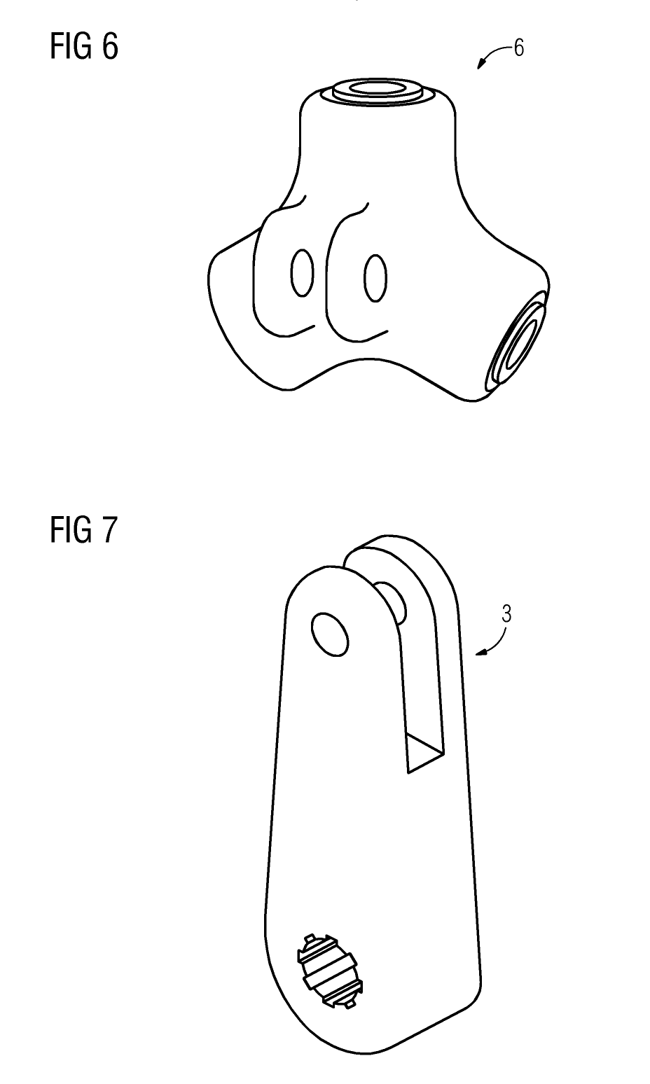

FIG. 4 shows schematically the three moving contacts 2 connected by the insulator 6 in FIG. 1, FIG. 6 shows schematically the insulator 6 in FIG. 4, and FIG. 7 shows schematically a crank arm 3 connected to the insulator 6 in FIG. 1, wherein the crank arm 3 can drive the moving contacts 2 to slide on the first conductors 1.

FIG. 5 shows schematically the three second conductors 5 mounted on the insulating disk 7 and corresponding second static contacts 51 in FIG. 1, wherein the three second conductors 5 are arranged in a regular triangle on the insulating disk 7 of the housing 8, and when two of the three second conductors 5 are disposed close to corresponding first conductors 1 at equal distances, respectively, these two second conductors 5 are bent. According to one embodiment which is not shown, when both the three first conductors 1 and the three second conductors 5 are arranged in a regular triangle on the insulating disk 7 of the housing 8, only one of the second conductors 5 is disposed close to the first conductor 1, and bending this single second conductor 5 helps to reduce the number of conductor processing steps and achieve a simpler structure.

As FIG. 1 shows, the housing 8 may be T-shaped or cross-shaped as required, and comprises a horizontal portion and a vertical portion, wherein the first conductors 1 are located in the horizontal portion, while the second conductors 5 are located in the vertical portion. In addition, the switch may also comprise a driving mechanism connected to the crank arm 3, the driving mechanism being able to drive the crank arm 3 and thereby drive the sliding movement of the moving contacts 2.

The series of detailed illustrations set forth above are merely specific illustrations of feasible embodiments of the present invention, and are by no means intended to limit the scope of protection of the present invention. All equivalent embodiments or modifications made without departing from the artistic spirit of the present invention should be included within the scope of protection thereof.

1-10. (canceled)

11. An isolating/grounding switch with three phases in one enclosure, the switch comprising:
a housing;
three first conductors and three first static contacts each connected to a respective one of said first conductors
three second conductors and three second static contacts each connected to a respective one of said second conductors;
each of said first static contacts and a corresponding one of said first conductors being coaxially disposed on a common axis with a corresponding one of said second static contacts and a corresponding one of said second conductors;
three grounding contacts electrically connected to said housing;
three moving contacts and an insulator connected thereto, each of said moving contacts being slidably mounted for moving between a first end and a second end of a corresponding one of said first conductors and being electrically connected to said one first conductor;
each of said moving contacts, when disposed at said first end of the corresponding one of said first conductors, being electrically connected to a corresponding one of said second static contacts and, when disposed at said second end of the corresponding one of said first conductors, being electrically connected to a corresponding one of said grounding contacts.

12. The isolating/grounding switch according to claim 11, wherein said first conductors are arranged in a triangle relationship on an insulating disk of said housing.

13. The isolating/grounding switch according to claim 12, wherein said first conductors are arranged in a regular triangle on said insulating disk.

14. The isolating/grounding switch according to claim 11, wherein said grounding contacts are three annular grounding contacts, each of said first conductors passing through a respective one of said grounding contacts, and said grounding contacts being separately connected to said housing.

15. The isolating/grounding switch according to claim 11, which further comprises a crank arm connected to said insulator and enabled to drive said moving contacts to slide on said first conductors.

16. The isolating/grounding switch according to claim 13, wherein said second conductors are arranged in a regular triangle on said insulating disk of said housing, and at least one of said second conductors is bent.

17. The isolating/grounding switch according to claim 16, wherein only one of said second conductors is bent.

18. The isolating/grounding switch according to claim 11, wherein said housing is a T-shaped housing comprising a horizontal portion and a vertical portion, said first conductors are disposed in said horizontal portion, and said second conductors are disposed in said vertical portion.

19. The isolating/grounding switch according to claim 11, wherein said housing is a cross-shaped housing comprising a horizontal portion and a vertical portion, said first conductors are disposed in said horizontal portion, and said second conductors are disposed in said vertical portion.

20. The isolating/grounding switch according to claim 11, which further comprises a driving mechanism and a crank arm connected between said driving mechanism and said insulator, wherein said driving mechanism is configured to drive said crank arm and thereby said moving contacts in a sliding movement.
